(19) United States
(12) Patent Application Publication
(10) Pub. No.: US 2026/0072588 A1
(43) Pub. Date: Mar. 12, 2026

(54) CONTROL DEVICE AND STORAGE DEVICE INCLUDING THE SAME

(71) Applicant: SK hynix Inc., Icheon-si (KR)

(72) Inventors: Dong Wook KIM, Icheon-si (KR); Jeong Su PARK, Icheon-si (KR); Jae Hoon HEO, Icheon-si (KR)

(21) Appl. No.: 19/035,248

(22) Filed: Jan. 23, 2025

(30) Foreign Application Priority Data
Sep. 12, 2024 (KR) 10-2024-0124367

(51) Int. Cl. G06F 3/06

(52) U.S. Cl. CPC G06F 3/0604; G06F 3/0659; G06F 3/0679

(57) ABSTRACT

A storage device separately manages trim range information, which indicates a trim region based on a trim command received from a host device, and trim state information, which indicates a progress state of a trim operation for the trim region. The storage device skips updating the trim state information based on the trim range information when a trim command for an overlapping trim region is generated. This approach helps prevent performance degradation in the storage device due to unnecessary updates and trim operations.

### CROSS-REFERENCE TO RELATED APPLICATION

The present application claims priority under 35 U.S.C. § 119(a) to Korean Patent Application No. 10-2024-0124367 filed in the Korean Intellectual Property Office on Sep. 12, 2024, which is incorporated herein by reference in its entirety.

### BACKGROUND

### 1. Technical Field

Embodiments of the present disclosure generally relate to a control device and a storage device including the same.

### 2. Related Art

A storage device may include at least one memory which stores data. The storage device may further include a controller which controls operations of the at least one memory.

The controller may control operations of the memory based on a request (or command) received from a host device external to the storage device. For example, in response to a request (or command) from the host device, the controller may control an operation such as writing data to the memory, reading data from the memory, or erasing stored data.

While processing a request (or command) from the host device, the controller may receive a new request (or command) from the host device. This can pose a potential issue, as the operational performance of the storage device may degrade depending on a current control state of the controller while handling the new request (or command).

### SUMMARY

Various embodiments of the present disclosure are directed to preventing degradation in operational performance caused by processing a command from a host device, by managing information related to the command during an operation control process of a storage device based on the command and performing the operation control process based on the managed information.

In an embodiment, a storage device may include: at least one memory including a plurality of storage regions; and a controller configured to: upon receiving a trim command requesting a trim operation for at least one of the plurality of storage regions, determine whether to update trim range information based on a trim region specified by the trim command and to update trim state information indicating a progress state of the trim operation for the trim region; and skip the updates when the trim region specified by the trim command is included in a trim region indicated by previously stored trim range information.

In an embodiment, a storage device may include: a first memory; a second memory; and a controller configured to: receive a trim command requesting a trim operation for at least a portion of the first memory; set trim range information based on a trim region specified by the trim command; and store the trim range information in the second memory.

In an embodiment, a control device may include: a sub-memory; and a control circuit configured to, upon receiving from an external device a trim command requesting a trim operation for an external memory located outside the sub-memory: set trim range information based on a trim region specified by the trim command; and store the trim range information in the sub-memory.

According to the embodiments of the present disclosure, since the storage device manages the information related to a command received from the host device and determines how to process a new command received from the host device based on the managed information, it is possible to prevent degradation in the operational performance of the storage device when handling the new command from the host device.

### BRIEF DESCRIPTION OF THE DRAWINGS

FIG. 1 illustrates a storage device according to an embodiment of the present disclosure.

FIG. 2 illustrates an example of how the storage device manages information related to a trim command, according to an embodiment of the present disclosure.

FIGS. 3 to 6 illustrate examples of how the storage device operates after receiving a trim command, according to embodiments of the present disclosure.

FIG. 7 illustrates examples of operation states based on commands received by the storage device, according to an embodiment of the present disclosure.

FIG. 8 illustrates examples of how trim range information is managed based on commands received by the storage device, according to an embodiment of the present disclosure.

FIG. 9 illustrates an example of how the storage device operates upon receiving a trim command, according to an embodiment of the present disclosure.

FIG. 10 illustrates an example of how the storage device performs a trim operation in response to a trim command, according to an embodiment of the present disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including,” “having,” “containing,” “constituting,” “make up of,” and “formed of” used herein are generally intended to allow other components to be added unless the terms are used with the term “only.” As used herein, singular forms are intended to include plural forms unless the context clearly indicates otherwise.

Terms, such as “first,” “second,” “A,” “B,” “(A),” or “(B)” may be used herein to describe elements of the present disclosure. Each of these terms is not used to define essence, order, sequence, or number of elements etc., but is used merely to distinguish the corresponding element from other elements.

When it is mentioned that a first element “is connected or coupled to,” or “contacts or overlaps” a second element, it should be interpreted that, not only can the first element “be directly connected or coupled to” or “directly contact or overlap” the second element, but a third element can also be “interposed” between the first and second elements, or the first and second elements can “be connected or coupled to,” or “contact or overlap” each other via a fourth element. Here, the second element may be included in at least one of two or more elements that “are connected or coupled to,” or “contact or overlap” each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can.”

Hereinafter, various embodiments of the present disclosure will be described in detail with reference to accompanying drawings.

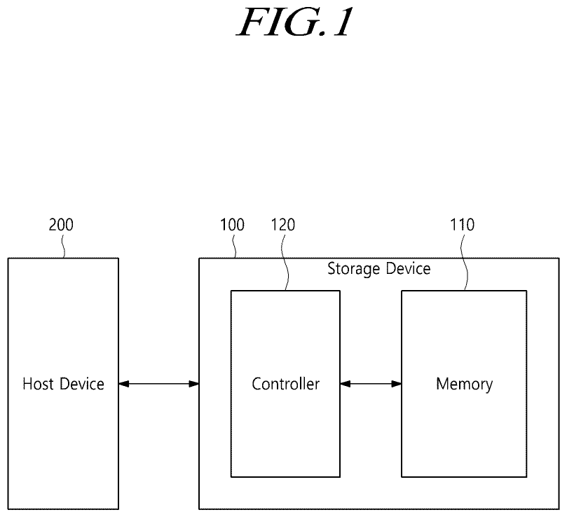

FIG. 1 illustrates a storage device 100 according to an embodiment of the present disclosure.

Referring to FIG. 1, the storage device 100 may include at least one memory 110. The storage device 100 may further include a controller 120 configured to manage and control operations of the memory 110.

The memory 110 may include volatile memory such as DRAM, SDRAM, DDR SDRAM, or LPDDR SDRAM, but the embodiments of the present disclosure are not limited thereto. In another embodiment, the memory 110 may include nonvolatile memory such as NAND flash memory, 3D NAND flash memory, or NOR flash memory. In yet another embodiment, the memory 110 may include both volatile memory and nonvolatile memory.

In addition, the memory 110 may be any of various types of memory, such as resistive RAM, phase change memory, magnetoresistive memory, ferroelectric memory, or spin transfer torque memory. As the case may be, the memory 110 may function as a processing-in-memory (PIM) device, incorporating a calculation function or a data processing function.

The controller 120 may receive a command from an external device and control the operation of the memory 110 based on the received command. In addition, the controller 120 may control the operation of the memory 110 based on an internally generated command. In the present specification, a command received by the controller 120 from the external device may be referred to as an ‘external command,’ while a command generated internally by the controller 120 may be referred to as an ‘internal command.’

The controller 120 may control the operation of the memory 110 based on the external command or the internal command. For example, the controller 120 may control an operation of writing data to the memory 110 and an operation of reading data from the memory 110. Data may be transmitted between the controller 120 and the memory 110.

Depending on the type of the memory 110, the controller 120 may manage data preservation operations (e.g., refresh or patrol scrub operations) or data erase operations on the memory 110.

In order to maintain or enhance the operational performance of the storage device 100, the controller 120 may perform a background operation related to the memory 110, based on either an external command received from a host device 200 or an internal command. The background operation may include garbage collection, wear leveling, read reclaim, or bad block management. By controlling the background operation, the controller 120 may enhance the operational performance of the storage device 100 or prevent the operational performance from degrading.

The controller 120 may control the operation of the memory 110 based on a command received from the host device 200, and provide the host device 200 with a processing result of the corresponding operation. The controller 120 may transmit data or a response signal to the host device 200.

For example, the host device 200 may be a computer, an ultra-mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a telematics network, an RFID (radio frequency identification) device, a mobility device (e.g., a vehicle, a robot or a drone) capable of traveling under human control or autonomous driving, or the like. Alternatively, the host device 200 may be a virtual/augmented reality device configured to provide a 2D or 3D virtual reality image or augmented reality image. Besides, the host device 200 may be any electronic device that requires the storage device 100 for data storage.

The host device 200 may include at least one operating system. The operating system may manage and control overall functions and operations of the host device 200, and may control an interoperation between the host device 200 and the storage device 100. The operating system may be classified into a general operating system and a mobile operating system depending on the mobility of the host device 200.

The host device 200 may communicate with the storage device 100 using various interface protocols. For example, the host device 200 and the storage device 100 may communicate using at least one of various interface protocols, such as a USB (universal serial bus) protocol, an MMC (multimedia card) protocol, an eMMC (embedded multimedia card) protocol, a UFS (universal flash storage) protocol, an NVMe (nonvolatile memory express) protocol, a PCI (peripheral component interconnection) protocol, a PCI-E (PCI-express) protocol, an ATA (advanced technology attachment) protocol, a serial-ATA protocol, a parallel-ATA protocol, an SCSI (small computer system interface) protocol, an ESDI (enhanced small disk interface) protocol, or an IDE (integrated drive electronics) protocol, but are not limited thereto. As the case may be, the host device 200 may communicate with the storage device 100 using a CXL (compute express link) interface.

The controller 120 and the host device 200 may be devices which are separated from each other. As the case may be, the controller 120 and the host device 200 may be integrated into a single device, or some components or functions of the controller 120 may be incorporated into the host device 200. For the sake of convenience in explanation, the following description will assume that the controller 120 and the host device 200 are devices which are separated from each other.

The controller 120 may perform operation control based on various commands received from the host device 200. The controller 120 may receive a write command, a read command, and a trim command from the host device 200. The controller 120 may perform operation control based on each command received from the host device 200. In order to more efficiently perform operation control, the controller 120 may manage information related to each command while performing the corresponding control operation.

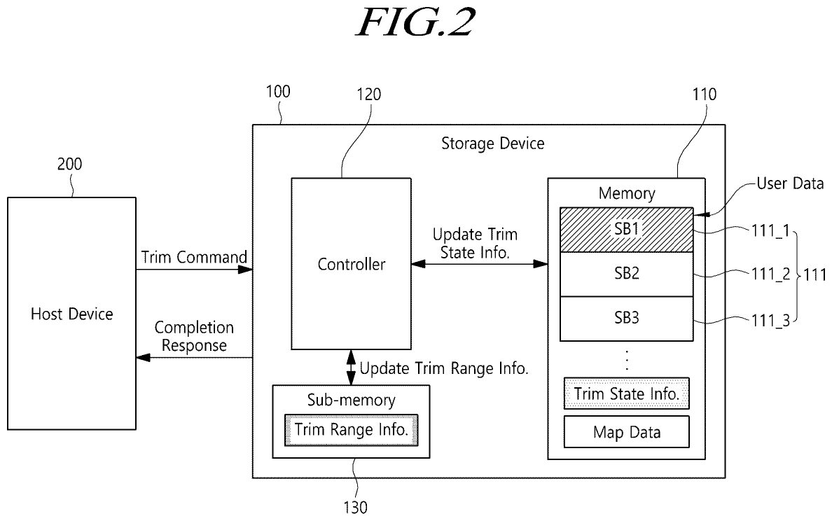

FIG. 2 illustrates an example of how the storage device 100 manages information related to a trim command, according to an embodiment of the present disclosure.

Referring to FIG. 2, the storage device 100 may include at least one memory 110 and the controller 120. The controller 120 may control the operations of the memory 110 in response to a request (or command) from the host device 200 while communicating with the host device 200.

The storage device 100 may further include at least one sub-memory 130 which stores data required in the operation control process of the controller 120. The sub-memory 130 may include volatile memory such as DRAM, SRAM, or the like, but is not limited thereto. In FIG. 2, the sub-memory 130 is located outside the controller 120. Alternatively, the sub-memory 130 may be located inside the controller 120. In some cases, sub-memories 130 may be disposed both inside and outside the controller 120, and may store data required for operation control of the controller 120.

The sub-memory 130 and the controller 120 may collectively be referred to as a control device, with the controller 120 being referred to as a control circuit in this context. In the present specification, the memory 110 may be referred to as an external memory to distinguish it from the sub-memory 130. The memory 110 may also be referred to as a first memory, while the sub-memory 130 may be referred to as a second memory.

The memory 110 may include a plurality of storage regions 111 (e.g., 111_1, 111_2, 111_3, . . . ). The plurality of storage regions 111 may include at least one region for storing user data used by the host device 200 and at least one region for storing metadata associated with the user data. FIG. 2 illustrates an example in which user data is written to a first storage region 111_1 among the plurality of storage regions 111 included in the memory 110.

Various metadata may be stored in some of the plurality of storage regions 111 of the memory 110. For example, among the various metadata, map data may be stored in at least one storage regions in the memory 110. The map data may include information on the mapping relationship between a logical address used by the host device 200 and a physical address of a storage region 111 included in the memory 110.

The controller 120 may store and manage the map data in the memory 110 and, in an operation, may load and use at least a part of the map data in the sub-memory 130.

The controller 120 may perform operation control in response to various commands received from the host device 200, and may store and manage information related to the various commands in the memory 110 or the sub-memory 130.

For example, the controller 120 may store and manage information related to a trim command received from the host device 200 in the memory 110 or the sub-memory 130. The controller 120 may perform operation control in response to the trim command based on the information related to the trim command.

The controller 120 may receive the trim command from the host device 200. The trim command may request a trim operation for a storage region 111 that stores data according to a request from the host device 200. A trim region specified by the trim command may indicate a storage region associated with a logical address used by the host device 200.

In response to the trim command, the controller 120 may erase the data stored in the corresponding storage region 111, i.e., the trim region, mark the data as invalid data, or release the mapping relationship between the logical address and a physical address associated with the corresponding storage region 111.

In response to the trim command received from the host device 200, the controller 120 may adjust the timing of the trim operation.

For example, upon receiving the trim command, the controller 120 may perform the trim operation and transmit a completion response signal to the host device 200.

Alternatively, upon receiving the trim command, the controller 120 may update information based on the trim command, transmit a completion response signal, and then perform the trim operation at a preset time. For example, the controller 120 may perform the trim operation during a background operation.

Upon receiving the trim command from the host device 200, the controller 120 may generate or update information on the trim region targeted for the trim operation.

For example, the controller 120 may generate or update trim range information that specifies the extent of the trim region targeted for the trim operation. The controller 120 may set the trim range information using, for example, start position information and end position information of the trim region. Alternatively, the controller 120 may set the trim range information in the form of a bitmap. Other methods of setting the trim range information may also be utilized.

The controller 120 may store the trim range information in the memory 110 or the sub-memory 130. Alternatively, the controller 120 may store the trim range information only in the sub-memory 130 and may not store the trim range information in the memory 110.

In addition to the trim range information, the controller 120 may generate or update trim state information to indicate a progress state of the trim operation for the trim region. For example, the controller 120 may set the trim state information in the form of a bitmap to indicate the status of the trim region for the trim operation.

The controller 120 may perform the trim operation for the trim region based on the trim state information. The controller 120 may update the trim state information when the trim operation for the trim region is completed.

Upon receiving the trim command from the host device 200, the controller 120 may set the trim range information and the trim state information based on the trim command and transmit the completion response signal to the host device 200. The trim range information may be stored in the sub-memory 130, and the trim state information may be stored in the memory 110. In another embodiment, both the trim range information and the trim state information may be stored in the memory 110.

When the trim range information and the trim state information associated with the trim command are stored in the memory 110 or the sub-memory 130, the controller 120 may perform the trim operation during a preset period, such as a background operation period, in response to the trim command.

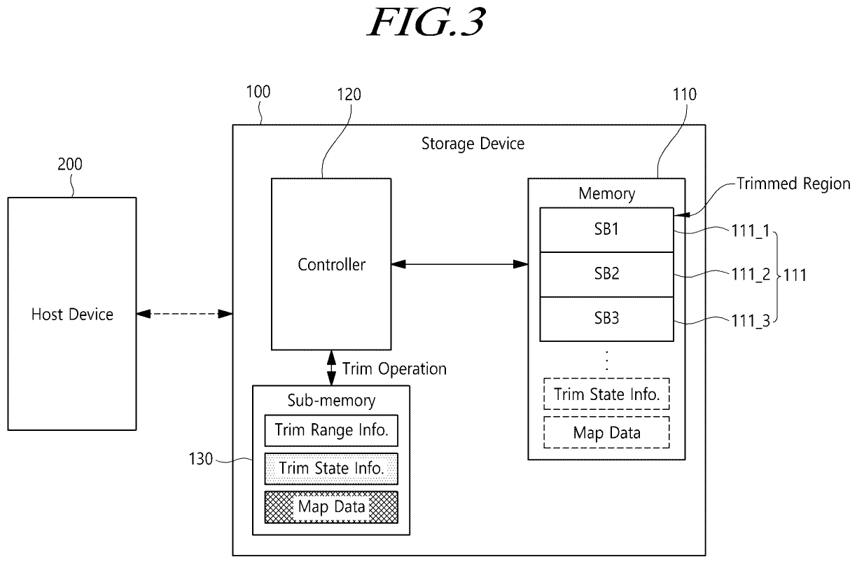

FIGS. 3 to 6 illustrate examples of how the storage device 100 operates after receiving a trim command, according to embodiments of the present disclosure.

Referring to FIG. 3, the controller 120 may store and manage the trim range information and the trim state information in response to the trim command received from the host device 200.

The controller 120 may perform a trim operation based on the trim state information during a preset period, such as a background operation period.

For example, the controller 120 may load the trim state information stored in the memory 110 into the sub-memory 130. Alternatively, it may be a state in which the trim state information is loaded into the sub-memory 130.

The controller 120 may load map data stored in the memory 110 into the sub-memory 130. Alternatively, it may be a state in which the map data is loaded into the sub-memory 130 according to read operation control performed by the controller 120 or the like.

The controller 120 may perform the trim operation based on the trim state information loaded into the sub-memory 130. For example, the controller 120 may receive a trim command requesting a trim operation for the first storage region 111_1, where user data is stored, as descried with reference to FIG. 2. The controller 120 may perform the trim operation for the first storage region 111_1 in response to the trim command.

The controller 120 may either perform an erase operation for the first storage region 111_1 or mark the data stored in the first storage region 111_1 as invalid.

The controller 120 may perform the trim operation for the first storage region 111_1 based on trim state information loaded into the sub-memory 130, and may update map data loaded into the sub-memory 130. The controller 120 may perform the trim operation on the first storage region 111_1 through the updating of the map data. The controller 120 may update the trim state information which reflects a progress state of the trim operation for the first storage region 111_1, as the trim operation proceeds.

In this case, the controller 120 may not update the trim range information stored in the sub-memory 130. While performing the trim operation, the controller 120 may maintain the trim range information without updating it.

After performing the trim operation, the controller 120 may receive a new command from the host device 200. The controller 120 may receive a write command or a read command from the host device 200, or may receive a new trim command from the host device 200.

As the case may be, the controller 120 may receive a new trim command from the host device 200, instructing a trim operation for a trim region that overlaps at least partially with the trim region for which the trim operation was performed.

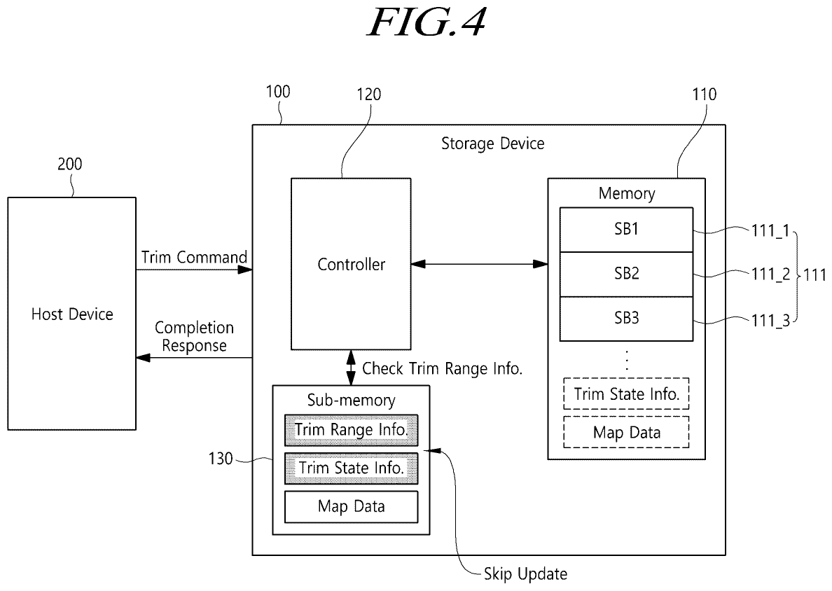

For example, referring to FIG. 4, the controller 120 may receive a new trim command from the host device 200 after performing the trim operation. Before receiving the new trim command, the controller 120 may receive a write command or a read command and perform an operation according to the corresponding command.

Upon receiving the new trim command from the host device 200, the controller 120 may check a trim region as a target of a trim operation corresponding to the new trim command. The controller 120 may check the previously stored trim range information. The controller 120 may check whether the trim region specified by the new trim command is included in the previously stored trim range information.

If the trim region specified by the new trim command is not included in a trim region indicated by the previously stored trim range information, the controller 120 may update the trim range information and the trim state information accordingly.

After updating the trim range information and the trim state information, the controller 120 may transmit a completion response signal to the host device 200. Similarly to the example described with reference to FIG. 3, the controller 120 may perform the trim operation based on the updated trim state information during a preset period.

If the trim region specified by the new trim command is included in the trim region indicated by the previously stored trim range information, the controller 120 may refrain from updating both the trim range information and the trim state information.

After skipping the updates to the trim range information and the trim state information, the controller 120 may transmit the completion response signal to the host device 200.

The controller 120 may manage the trim range information separately and use it to determine whether to update the trim state information in response to a new trim command.

If the trim state information is updated following the completion of the previous trim operation before the controller 120 receives the new trim command, since a region where the previous trim operation was performed is indicated by the trim range information, the controller 120 may skip updating the trim state information when the trim region specified by the new trim command overlaps the region indicated by the trim range information.

The controller 120 may skip updating the trim range information and the trim state information in response to the new trim command, and may not separately perform a trim operation based on the trim state information. By avoiding an unnecessary trim operation in response to the new trim command, the controller 120 can process another command from the host device 200, thereby improving the operational performance of the storage device.

After skipping the updates to the trim range information and the trim state information, the controller 120 may determine and manage whether to update the trim range information and the trim state information based on a new command received from the host device 200.

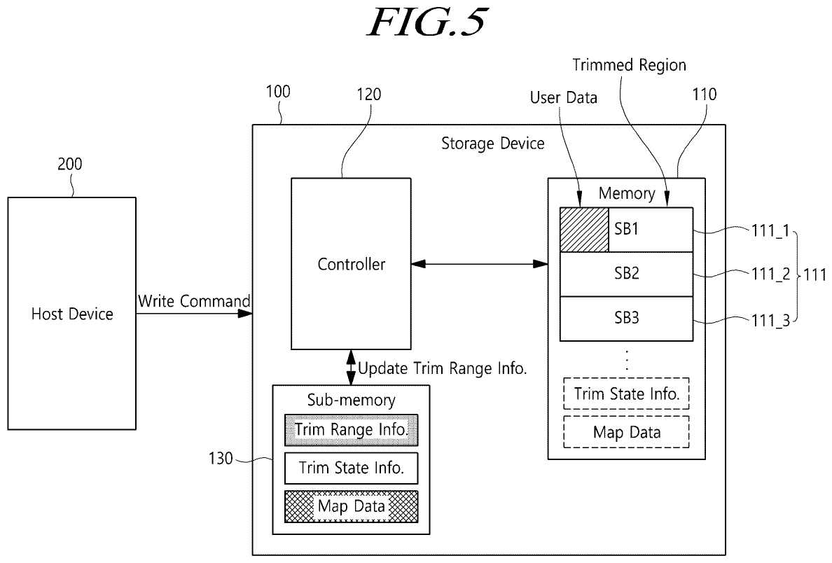

For example, referring to FIG. 5, after completing the trim operation for the first storage region 111_1, the controller 120 may receive a write command from the host device 200.

The controller 120 may control a write operation in response to the write command, and for example, data may be written to a portion of the first storage region 111_1.

When a write command or a read command is received, the controller 120 may not update the trim range information stored in the sub-memory 130. Alternatively, when a write command is received, the controller 120 may update the trim range information stored in the sub-memory 130.

For example, a region where the data is written in response to the write command may overlap with the region where the trim operation was performed. For the sake of convenience in explanation, FIG. 5 illustrates an example in which data is written to the first storage region 111_1, where the trim operation was performed, in the memory 110. The fact that the region specified by the write command corresponds to the region specified by the trim command may mean a case where a logical address corresponding to the write command matches a logical address in which the trim operation was performed.

When the logical address corresponding to the write command matches the logical address corresponding to the trim command, the controller 120 may update the previously stored trim range information. When the data is written to the region specified by the corresponding logical address in response to the write command, the controller 120 may update the trim range information to exclude the region where the data is written from the trim region specified by the logical address corresponding to the trim command.

By updating the previously stored trim range information based on a new trim command or a new write command received from the host device 200, the controller 120 may efficiently perform a trim operation when a trim command for an overlapping region is received.

The controller 120 may update the trim range information or the trim state information based on a new trim command received from the host device 200 after performing the write operation.

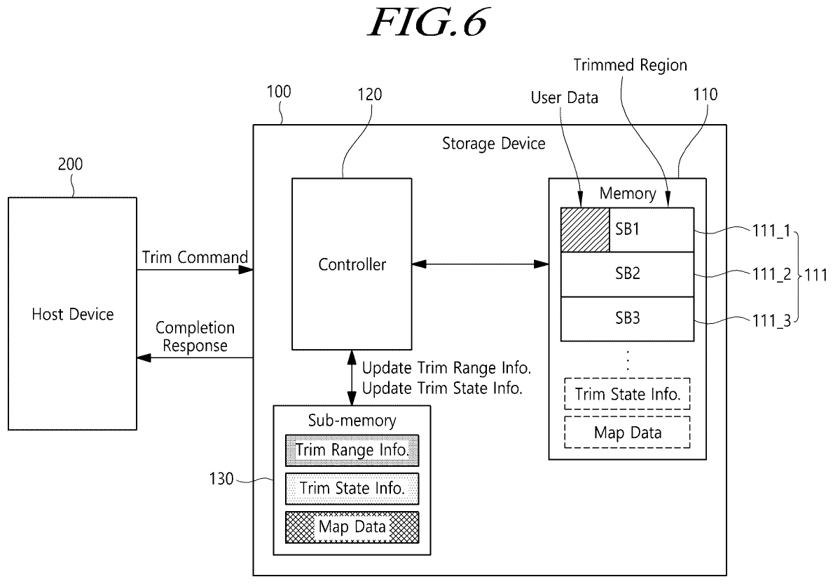

For example, referring to FIG. 6, after updating the previously stored trim range information based on the write command as illustrated in FIG. 5, the controller 120 may receive a new trim command from the host device 200.

A trim region specified by the new trim command may be, for example, the same region as the region where the trim operation was performed as illustrated in FIG. 3. For the sake of convenience in explanation, FIG. 6 illustrates the first storage region 111_1 as the region indicated by the new trim command, but this may mean a case where a logical address corresponding to the new trim command is the same as the logical address of the trim region where the trim operation was performed as illustrated in FIG. 3.

Since the trim region specified by the trim command includes a region other than the trim region indicated by the previously stored trim range information, the controller 120 may update the previously stored trim range information based on the trim region corresponding to the trim command.

The controller 120 may update the trim state information based on the update of the trim range information. In this case, since part of the trim region specified by the trim command has already completed the trim operation and the other part has data written to it, the trim state information may be updated only for the portion where the data is written.

Since the controller 120 sets and manages trim range information based on a trim region specified by a trim command, when a different type of command or a new trim command is received after receiving a previous trim command from the host device 200, updating trim range information may enable the controller 120 to efficiently perform a trim operation based on the new trim command.

Even when receiving multiple trim commands from the host device 200, performance degradation due to trim operations may be prevented.

The aforementioned cases may occur during a normal operation of the storage device 100 or while testing the storage device 100. As shown in the examples in FIGS. 5 and 6, even when a new trim command is received for the entire existing trim region after data is written to a part of the trim region where the trim operation was performed, the efficiency of the trim operation can be improved through the management of trim range information and partial updates of trim state information. Alternatively, the embodiments of the present disclosure may be applied to various cases involving the repeated execution of trim commands.

In addition, even when multiple trim commands are received during testing the storage device 100, the efficiency of trim operations can be improved through the management of the trim range information and trim state information.

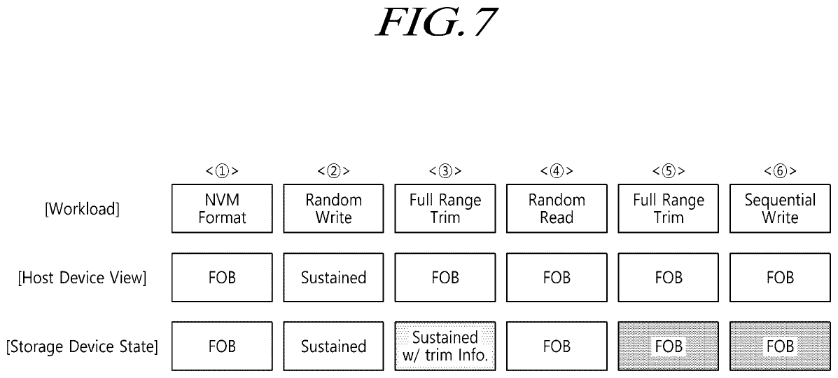

FIG. 7 illustrates examples of operation states based on commands received by the storage device 100 according to an embodiment of the present disclosure.

Referring to FIG. 7, the host device 200 may test the performance of the storage device 100 by transmitting various commands to the storage device 100. For example, as shown in \textcircled{1}, a formatting operation may be performed on the memory 110 of the storage device 100. In this case, the storage device 100 may be in an FOB (fresh of box) state, which the host device 200 recognizes as such. The FOB state refers to a condition where no data is stored in the memory 110, and no garbage collection operation has occurred to organize the storage regions 111.

When the storage device 100 is in the FOB state, a write command from the host device 200 may be generated, as shown in \textcircled{2}. In response, the storage device 100 may write data to the memory 110 and enter a sustained state as a result of the data writing. The sustained state refers to a condition where free storage regions are limited among the storage regions 111 due to the write operation, which triggers a garbage collection operation. This garbage collection may lead to performance degradation of the storage device 100.

In the sustained state of the storage device 100, the host device 200 may generate a trim command for all regions, as shown in \textcircled{3}. By generating the trim command, the host device 200 may recognize that the storage device 100 is in an FOB state. In response, the storage device 100 may transmit a completion response signal to the host device 200. Since the completion response signal is sent to the host device 200 before performing the trim operation, the storage device 100 may proceed to perform the trim operation based on trim state information in response to the trim command. During the trim operation, the storage device 100 may remain in a sustained state. Once the trim operation is completed, the storage device 100 transitions to an FOB state.

In order to test performance, the host device 200 may transmit either a read command or a write command to the storage device 100.

For example, after transmitting the trim command, the host device 200 may generate a read command, as shown in \textcircled{4}, to check the completion state of the trim operation on the storage device 100.

The host device 200 may generate a trim command for the entire memory 110, as shown in \textcircled{5}, and subsequently generate a write command to instruct data writing to the memory 110, as shown in \textcircled{6}.

When the storage device 100 receives the trim command, as shown in \textcircled{5}, the storage device 100 may skip updating the trim state information based on the preset trim range information that was set in \textcircled{3}.

The host device 200, which transmits the trim command in \textcircled{5}, may recognize that the storage device 100 is in an FOB state. In response, the storage device 100 may skip updating the trim state information and remain in an FOB state. By skipping the update of the trim state information, performance degradation due to the update operation may be prevented.

Then, in \textcircled{6}, the storage device 100 may perform a write operation in response to the write command without delay, thereby improving the operational performance of the storage device 100.

By setting and managing the trim range information based on the trim command from the host device 200 and determining whether to update the trim state information according to the trim command, the storage device 100 can reduce performance degradation caused by controlling and managing the trim operation in response to the trim command.

The storage device 100 may manage trim range information in various forms. For example, it may set trim range information using start position information and end position information of a trim region specified by a trim command.

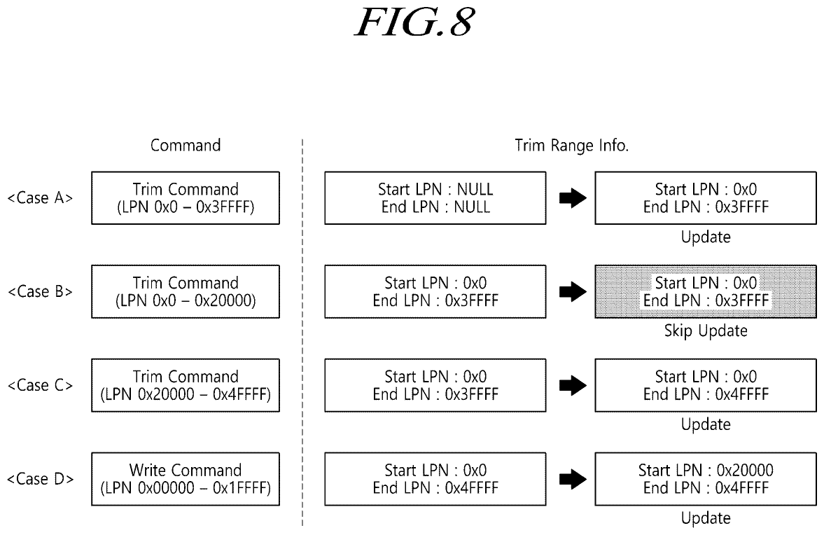

FIG. 8 illustrates examples of how trim range information is managed based on commands received by the storage device 100 according to an embodiment of the present disclosure.

Referring to FIG. 8, the controller 120 may manage trim range information separately from trim state information based on a command received from the host device 200.

The controller 120 may generate trim range information to include start position information and end position information of a trim region as a target of a trim operation in response to a trim command. Alternatively, the controller 120 may manage trim range information in the form of a bitmap, similarly to trim state information. In this case, the bitmaps for trim range information and trim state information may be managed separately.

As shown in <Case A>, the controller 120 may receive a first trim command from the host device 200. A trim region specified by the first trim command may correspond to, for example, logical addresses (or logical page numbers) from 0x0 to 0x3FFFF.

In response to the first trim command, the controller 120 may set trim range information with a NULL value, using start position information of 0x0 and end position information of 0x3FFFF.

With the trim range information set from 0x0 to 0x3FFFF, the controller 120 may receive various commands from the host device 200. For example, as shown in <Case B>, a second trim command may be received. A trim region specified by the second trim command may correspond to, for example, logical addresses from 0x0 to 0x20000.

In this case, the trim region specified by the second trim command may be included in previously stored trim range information. Therefore, the controller 120 may choose not to update the previously stored trim range information. By skipping the update of the trim range information and not updating trim state information, performance degradation due to the update of trim state information for an overlapping trim region can be prevented.

After skipping the update of trim range information, as shown in <Case C>, the controller 120 may receive a third trim command. A trim region specified by the third trim command may correspond to, for example, logical addresses from 0x20000 to 0x4FFFF.

A portion of the trim region specified by the third trim command may overlap with the trim region indicated by the previously stored trim range information, while the remainder of the trim region may not. The controller 120 may update the previously stored trim range information based on the remainder of the trim region specified by the third trim command. Accordingly, the trim range information may be updated to reflect start position information of 0x0 and end position information of 0x4FFFF.

Once the trim range information is set, the controller 120 may receive a command other than a trim command.

For example, as shown in <Case D>, the controller 120 may receive a write command from the host device 200. Logical addresses for data associated with the write command may range from 0x0000 to 0x1FFFF. A region specified by the write command may overlap with the previously stored trim range information.

The controller 120 may write the data to a storage region 111 indicated by physical addresses mapped to the corresponding logical addresses specified by the write command.

Since the region indicated by the logical addresses specified by the write command is not a target of a trim operation, the controller 120 may update the previously stored trim range information. By excluding the region indicated by the logical addresses from the previously stored trim range information, the controller 120 may update the trim range information to reflect start position information of 0x20000 and end position information of 0x4FFFF.

The controller 120 may manage trim range information by updating it according to both trim commands and other commands received from the host device 200. Depending on whether the trim range information is updated, the update of trim state information and the control of the trim operation may be performed. By managing the trim range information, the controller 120 can skip unnecessary updates for overlapping trim regions, preventing the performance degradation of the storage device 100 caused by the unnecessary update and trim operations.

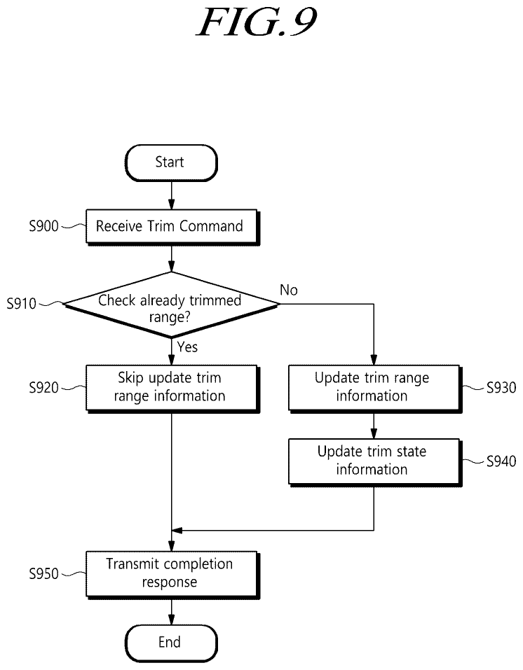

FIG. 9 illustrates an example of how the storage device 100 operates upon receiving a trim command, according to an embodiment of the present disclosure.

Referring to FIG. 9, an example is illustrated in which the storage device 100 manages trim range information while operating based on the reception of a trim command.

The storage device 100 may receive the trim command from the host device 200 (S900). The storage device 100 may then check whether a trim region specified by the received trim command has already performed a trim operation (S910). The storage device 100 may verify whether the trim region specified by the received trim command is included in previously stored trim range information.

When the trim region specified by the trim command is included in the previously stored trim range information, the storage device 100 may skip updating the trim range information (S920).

When the trim region specified by the trim command is not included in the previously stored trim range information, the storage device 100 may update the trim range information (S930). After updating the trim range information, the storage device 100 may also update trim state information (S940).

Once the trim range information and trim state information have been processed, the storage device 100 may transmit a completion response signal to the host device 200 (S950).

Since the storage device 100 determines whether to update the trim range information and trim state information by comparing the trim region specified by the received trim command with the previously stored trim range information, unnecessary updates to the trim state information can be prevented.

After setting trim range information, the storage device 100 may manage the trim range information based on the operation of the storage device 100 or any command received from the host device 200.

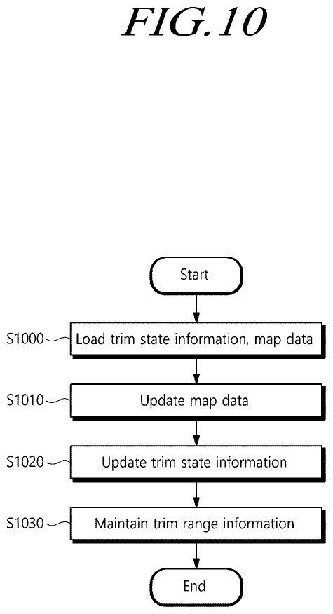

FIG. 10 illustrates an example of how the storage device 100 performs a trim operation according to a trim command, according to an embodiment of the present disclosure.

Referring to FIG. 10, after transmitting a completion response signal in response to a trim command, the storage device 100 may perform a trim operation as a background operation.

For example, the storage device 100 may load trim state information and map data into the sub-memory 130 (S1000).

The storage device 100 may update the map data according to the trim operation (S1010). The trim state information may also be updated based on the progress of the trim operation (S1020). For example, the storage device 100 may indicate a trim completion state by changing a setting value in the trim state information for a trim region where the trim operation is completed.

The storage device 100 may skip updating preset trim range information while updating the trim state information according to the trim operation (S1030). The trim range information may remain unchanged while the trim operation is being performed based on the trim command.

While maintaining the trim range information, the storage device 100 may determine whether to update the trim range information based on a new command received from the host device 200.

When the trim region specified by the new trim command overlaps with the preset trim range information, the storage device 100 may skip updating both the trim range information and the trim state information, thus preventing performance degradation due to unnecessary updates of trim state information and unnecessary trim operations.

Although various embodiments of the present disclosure have been described with particular specifics and varying details for illustrative purposes, those skilled in the art will appreciate that various modifications, additions and substitutions may be made based on what is disclosed or illustrated in the present disclosure without departing from the spirit and scope of the present disclosure as defined in the following claims.

What is claimed is:

1. A storage device, comprising:
at least one memory including a plurality of storage regions; and
a controller configured to:
upon receiving a trim command requesting a trim operation for at least one of the plurality of storage regions, determine whether to update trim range information based on a trim region specified by the trim command and to update trim state information indicating a progress state of the trim operation for the trim region; and
skip the updates when the trim region specified by the trim command is included in a trim region indicated by previously stored trim range information.

2. The storage device according to claim 1, wherein the controller skips the updates and transmits a completion response signal corresponding to the trim command to an external device that transmits the trim command.

3. The storage device according to claim 1, wherein, when a portion of the trim region specified by the trim command is included in the trim region indicated by the previously stored trim range information, the controller updates the previously stored trim range information and previously stored trim state information based on the remainder of the trim region specified by the trim command.

4. The storage device according to claim 3, wherein the controller updates the previously stored trim range information and the previously stored trim state information and transmits a completion response signal corresponding to the trim command to an external device that transmits the trim command.

5. The storage device according to claim 4, wherein the controller performs the trim operation based on the trim state information during a preset period after transmitting the completion response signal, and updates the trim state information based on progressing of the trim operation.

6. The storage device according to claim 5, wherein the controller updates the trim state information based on the progressing of the trim operation, while preserving the trim range information without updating.

7. The storage device according to claim 1, wherein, upon receiving a write command for at least a portion of the trim region indicated by the previously stored trim range information, the controller updates the previously stored trim range information based on the write command.

8. The storage device according to claim 1, wherein the controller stores the trim state information in the at least one memory, and stores the trim range information in a sub-memory external to the at least one memory.

9. The storage device according to claim 1, wherein the controller sets the trim range information based on start position information and end position information of the trim region indicated by the trim range information.

10. The storage device according to claim 1, wherein the controller sets the trim range information in the form of a first bitmap and sets the trim state information in the form of a second bitmap.

11. The storage device according to claim 1, wherein the controller is configured to:
receive a trim command requesting a trim operation for all of the plurality of storage regions and receive a read command; and
subsequently receive another trim command requesting a trim operation for all of the plurality of storage regions and receive a write command.

12. The storage device according to claim 1, wherein the controller is configured to:
receive, in a state in which data is written to entirety of a first storage region among the plurality of storage regions, a trim command for the entirety of the first storage region;
perform a trim operation based on said trim command; and
subsequently receive, in a state in which data is written to a portion of the first storage region, another trim command for the entirety of the first storage region.

13. A storage device, comprising:
a first memory;
a second memory; and
a controller configured to:
receive a trim command requesting a trim operation for at least a portion of the first memory;
set trim range information based on a trim region specified by the trim command; and
store the trim range information in the second memory.

14. The storage device according to claim 13, wherein the controller sets trim state information indicating a progress state of a trim operation for a trim region and stores the trim state information in the first memory.

15. The storage device according to claim 14, wherein, when entirety of the trim region specified by the trim command is included in a trim region indicated by previously stored trim range information, the controller skips updating the previously stored trim range information and previously stored trim state information.

16. The storage device according to claim 14, wherein the controller is configured to:
load map data and the trim state information stored in the first memory into the second memory;
perform the trim operation; and
update the map data based on the trim state information after the trim operation.

17. The storage device according to claim 16, wherein the controller updates the map data, and maintains the trim range information without updating.

18. A control device, comprising:
a sub-memory; and
a control circuit configured to, upon receiving from an external device a trim command requesting a trim operation for an external memory located outside the sub-memory:
set trim range information based on a trim region specified by the trim command; and
store the trim range information in the sub-memory.

19. The control device according to claim 18, wherein the control circuit sets trim state information indicating a progress state of the trim operation for the trim region, and stores the trim state information in the external memory.

20. The control device according to claim 19, wherein when entirety of the trim region specified by the trim command is included in a trim region indicated by previously stored trim range information, the control circuit skips updating the previously stored trim range information and the trim state information, and transmits a completion response signal to the external device.
